(19) United States
(12) Patent Application Publication
(10) Pub. No.: US 2003/0163734 A1
(43) Pub. Date: Aug. 28, 2003

(54) Methods for managing and dynamically configuring resources at data center

(76) Inventors: Yutaka Yoshimura, Hadano (JP); Toshiaki Tarui, Sagamihara (JP); Frederico Buchholz Maciel, Kokubunji (JP); Shin Kameyama, Kodaira (JP)

Correspondence Address: REED SMITH LLP, Suite 1400, 3110 Fairview Park Drive, Falls Church, VA, 22042, US

(21) Appl. No.: 10/217,474

(22) Filed: Aug. 14, 2002

(30) Foreign Application Priority Data
Feb. 26, 2002 (JP) P2002-048941

(51) Int. Cl. H04L 9/00

(52) U.S. Cl. 713/201

(57) ABSTRACT

At a data center, operation for security management, such as tampering checks, is automatically implemented for a server allocated to one user of the data center without declining the user task processing performance of the servers in the data center. If control is exerted to deallocate one of the severs out of the user tasks, a server is deallocated such that no new load is assigned to the server to be checked for security management. At user-specified time intervals at which such operation is to be performed for one of the servers allocated to a user, judgment is made regarding whether an idle server is available. If available, the idle server is allocated to the user to resume the work load of the server to be checked for security management. If it is determined that no idle server is available, the load on the server to be checked for security management is reduced so as to perform the check for security management on the server.

### FIELD OF THE INVENTION

The present invention relates to a mechanism and method for sharing the resources in a computer system among users. More particularly, the invention relates to methods for managing and dynamically configuring computer resources in a system comprising a plurality of computers interconnected as a network so as to perform operation necessary for security management during transactions responding to requests of a plurality of users, while keeping the operation of the resources satisfying the service agreements made beforehand between the service provider and each user.

### BACKGROUND OF THE INVENTION

To cut down the information-handling cost, businesses and companies that contract out the tasks of an in-house information system and the management of their Web site/pages to Application Service Providers (ASPs) are increasing. Most of the ASPs further contract out the procurement, practical use, and management of computer resources to data center service providers.

A data center service provider prepares a great number of computers as resources to share them among a plurality of user companies so as to cut down the running cost and to offer low-price services to the user companies. To provide and maintain security for each customer company, in most cases, different computers and storage resources are generally allocated to different user companies. A load distributor is placed in the preceding stage to the parallel arrangement of a plurality of computer resources so as to best use the plurality of computer resources. A group of a plurality of computers (servers) is allocated to each user company; for example, two servers to user company A and three servers to user company B. A representative address is assigned to each group of a plurality of servers. Incoming traffic to a representative address is evenly shared across the servers in the group. An example of the load distributor is an ACE director supplied by Alteon (Nikkei Open Systems 1999. 12, No. 81, pp. 128-131). The load distributor allots a load to the plurality of servers in a group. For allotting a load among the plurality of servers in the same group, two methods are commonly used: round robin and weighting. In the round robin method, the plurality of servers allocated to a user is evenly treated, and the load distributor allots an equal load to the plurality of servers in order. On the other hand, in the weighting method, a load fraction (weight) dedicated to each of the servers to share the load is preset, and the load is shared so that each server will serve only the load portion assigned to it out of the entire traffic load for the user. When applying the weighting method, normally, the administrator of the data center determines a weight to be assigned to a corresponding server in a group according to the server's processing capacity.

In a different way other than the load distribution among Web servers using the load distributor, load distribution among application servers and database servers is implemented.

In a data center operation, such a problem is encountered that concentrated access to a Web server at a site results in a decline in the server performance for a user. As a method for solving this problem, a Virtual Private Data Center (VPDC) is provided. In the VPDC system, there are servers not allocated to any user utilizing the data center and these servers are defined as idle servers. This system also includes a server that supervises the operating status of all servers allocated to all users, i.e., a managerial server. The VPDC implements the following control.

When the managerial server determines that the load on the servers allocated to a user is high while supervising the operating status of all servers allocated to the users, it additionally allocates an idle server to the particle user.

When the managerial server determines that the load on the servers allocated to a user is exceedingly low while supervising the operating status of all servers allocated to the users, it idles one of the servers allocated to the particular user.

Allocating an additional server to a user or idling a server is carried out by reconfiguring the load distributor and changing the contents that are referenced by the server. The contents include html files, CGI programs, XML files, PHP script files, SQL, etc.

To furnish a server with contents that belongs to a user, the following three methods may be available: (1) changing the contents file that is referenced by the server by mounting it form a Network File System (NFS) server; (2) rebooting the server to read the appropriate contents from a disk system on the network, while the disk system contains the contents for the accommodated users; and (3) cloning, that is, copying the original contents on a master server to each server.

It is essential for data center service providers and ASPs to provide and sustain security of data belonging to the users that utilize their services. Problems that may arise at a data center or the like in the absence of user data security include intrusion into a server by tampering with OS/application configuration files, and tampering with contents, typically, tampering with Web pages. Therefore, the data center service providers and ASPs check to ensure that data is not tampered with including the OS/application configuration files and contents on the servers under their management. To check the OS/application configuration files and contents for the service offered to a user and detect any part thereof affected by being tampered with, a data matching check tool is used. An example of the data matching check tool under the mark Tripwire® (Proceedings of the 2nd Conference on Computer and Communication Security, PP.18-29 “The Design and Implementation of Tripwire: A File System Integrity Checker”). The data matching check tool creates in advance checksums for the OS/application configuration files and the code or text of contents. Thereafter, checksums for the OS/application configuration files and the code or text of contents are created when a tampering check is performed and they are compared with the previously created checksums. If it is verified that security is ensured for the service offered by a server, the server's user task execution continues. If not, the administrator is warned of a fault and the server is disconnected from the user. When a tampering check is performed for a server, the load on the CPU of the server is so large as to affect the program execution for user tasks. The operation of security management for ensuring the security of a computer allocated to a user includes a virus check for the server computer. In detecting any tampered contents, when a virus check is performed for a server, the load on a 100% utilized CPU of the server is so large as to affect the program execution for user tasks, and it takes 20 to 30 minutes to execute the check.

Finally, standards for power management, referred to as the Advanced Power Management (APM), are established to decrease power consumption in the following manners:

(1) at a proper point of time, information retained in the main storage is transferred into a disk, saved to a backup file such that the power supply can be turned off; and (2) information is reloaded from the backup file into the main storage when required.

It is advised that the data retained by the server at the completion of its boot is to be stored into a disk as a backup file such that the server operating state can quickly recover without executing its booting procedure.

The above-described prior art management method for sharing resources or servers among users has the following problems.

Providing security for protecting the data belonging to the users served by a data center is burdensome to the network administrators at both user side and data center side. Tampering checks for OS/application configuration files and contents using a data matching check tool available now place a heavy load on the CPU of a server under check. These checks require considerable time and, consequently, the user would regard the server performance as declining in terms of job execution time or the like. Thus, in the actual situation, the tampering checks using the data matching check tool are performed only to a certain extent to avoid excessively high usage of the CPU of a server.

When tampering checks are performed for the servers allocated to the users, the administrator has to set the extent of the checks and make a schedule of the checks. This is a burden to the administrator of the data center where the contents and machine configuration changes in real time.

The object of the present invention is to provide a method for automatically controlling the operation essential for security management, such as tampering checks, without affecting the execution of user tasks thereby reducing the burden on the data center administrator, while ensuring user data security.

### SUMMARY OF THE INVENTION

In the present invention, if any servers allocated to a user is operating with exceedingly low load, a first management method of the present invention comprises the following three steps:

(1) reconfiguring the load distribution means and deallocating a server among the servers allocated to the user to be put through the operation for security management;

(2) performing the operation for security management for the deallocated server, while continuing furnishing the server with contents that belong to the user; and

(3) after the completion of the operation for security management, removing the contents belonging to the user from the server of resuming the workload back to the checked server.

In this method, because of the sufficiently low load on the servers allocated to the user, one of these servers is deallocated by the VPDC control and the load distribution means is reconfigured accordingly. The operation for security management is performed for the deallocated server with the server being furnished with contents that belong to the user, but user tasks being not assigned to the server. Because the operation for security management is performed for the server which is deallocated (idle) with its original work load taken over by other server(s), the offering of services to the user continues. Not only the OS/application configuration files but also the referenced contents belonging to the user can be checked through the operation for security management. A merit of this method is that the operation for security management can be performed for all OS/application configuration files for the server and all contents data belonging to the user.

A second management method for performing the operation for security management for a server allocated to a user is described below.

By allocating an idle server to a user when performing the operation for security management for a server allocated to the user, the second method comprises the following six steps:

(1) selecting a server to be put through the operation for security management;

(2) determining whether an idle server exists;

(3) if it is determined in step (2) that an idle server exists, allocating the idle server to the user, which further comprises reconfiguring the load distribution means to allocate the idle server to the user and furnishing the server with contents that belong to the user such that the server can reference the contents;

(4) reconfiguring the load distribution means to deallocate the server to be put through the operation for security management out of user tasks;

(5) performing the operation for security management for the deallocated server, while keeping the server furnished with the contents belonging to the user; and

(6) after the completion of the operation for security management, removing the contents belonging to the user from the server or resuming the work load back to the checked server.

An advantage of the second method is that both the OS/application configuration files for the services offered to the user and the referenced contents belonging to the user can be checked through the operation for security management without any decline in offering services to the user (as in the case for the first method).

To perform the operation for security management for a server without allocating an idle server, another method is applied. The third security management method comprises the following five steps:

(1) selecting a server to be put through the operation for security management;

(2) determining whether an idle server exists;

(3) if it is determined in step (2) that an idle server does not exist, changing the weighting set for the server in sharing the entire load in the load distribution means so as to reduce the load on the server to be put through the operation for security management;

(4) performing the operation for security management for the server; and

(5) after the completion of the operation for security management, reconfiguring the load distribution means and changing the weight set for the server in sharing the entire load in the load distribution means to resume the load on the server to that before the operation for security management.

An advantage of the third method is that the operation for security management can be performed for a server while minimizing the decline in offering services to the user. This is accomplished by changing the weighting in sharing the entire load for the server to be put through the operation for security management so as to reduce the load on the server before performing the operation for security management.

### BRIEF DESCRIPTION OF THE DRAWINGS

The foregoing and additional features and characteristics of the present invention will become more apparent from the following detailed description considered with reference to the accompanying drawings in which like reference numerals designate like elements and wherein:

FIG. 1 is a flowchart of a procedure in which one of the servers allocated to a user in a data center is deallocated/idled and the operation for security management is performed for the idled server, according to an Embodiment 1 of the present invention.

FIG. 2 is a block diagram in which clients connect to the data center in the Embodiment 1.

FIG. 3 is a block diagram of equipment configuration within the data center in the Embodiment 1.

FIG. 4 is a block diagram of information held by a managerial server included in the data center in the Embodiment 1.

FIG. 5 is a block diagram of information held by a load distributor included in the data center in the Embodiment 1.

FIG. 6 illustrates a window example provided for making a service level agreement between a user and the data center in the Embodiment 1.

FIG. 7 is a flowchart of a procedure in which the resources at the data center are shared across the users in the Embodiment 1.

FIG. 8 shows how to furnish the servers with individual contents (through an NFS server) in the Embodiment 1.

FIG. 9 shows how to furnish the servers with individual contents (through booting from a disk system on a network) in the Embodiment 1.

FIG. 10 shows how to furnish the servers with individual contents (by cloning) in the Embodiment 1.

FIG. 11 is a flowchart of a procedure in which one of the servers allocated to a user is deallocated and operation for security management is performed for the deallocated server when the manner of furnishing the servers with individual contents illustrated in FIG. 8 is applied.

FIG. 12 is a flowchart of a procedure in which one of the servers allocated to a user is deallocated and operation for security management is performed for the deallocated server when the manner of furnishing the servers with individual contents illustrated in FIG. 9 is applied.

FIG. 13 is a flowchart of a procedure in which one of the servers allocated to a user is deallocated and operation for security management is performed for the deallocated server when the manner of furnishing the servers with individual contents illustrated in FIG. 10 is applied.

FIG. 14 is a flowchart of a procedure in which operation for security management is periodically performed for one of the servers allocated to a user, according to an Embodiment 2.

FIG. 15 shows the minimum necessary information to be retained on the managerial server in the data center in the Embodiment 2 when the VPDC control is not exerted.

FIG. 16 shows information held by the managerial server in the data center in the Embodiment 2.

FIG. 17 shows information held by the load distributor in the data center in the Embodiment 2.

FIG. 18 illustrates a screen provided for making a security condition agreement between a user and the data center in the Embodiment 2.

FIG. 19 is a flowchart of a procedure in which the resources at the data center are shared across the users in the Embodiment 2.

FIG. 20 shows information held by the managerial server in a modification example 1 in which a virus check is performed.

FIG. 21 is a flowchart of a procedure of the modification example 1 in which one of the servers allocated to a user is deallocated and a virus check is performed for the deallocated server.

FIG. 22 is a flowchart of a procedure in which a virus check is periodically performed for one of the servers allocated to a user.

FIG. 23 shows information held by the managerial server in a modification example 2 in which a hardware check is performed.

FIG. 24 is a flowchart of a procedure of the modification example 2 in which one of the servers allocated to a user is deallocated and a hardware check is performed for the deallocated server.

FIG. 25 is a flowchart of a procedure of the modification example 2 in which a hardware check is periodically performed for one of the servers allocated to a user.

FIG. 26 shows information held by the managerial server in a modification example 3 in which a backup dump of a server is performed.

FIG. 27 is a flowchart of a procedure of the modification example 3 in which one of the servers allocated to a user is deallocated and a backup dump of the deallocated server is performed.

FIG. 28 is a flowchart of a procedure of the modification example 3 in which a backup dump is periodically performed for one of the servers allocated to a user.

### DETAILED DESCRIPTION OF THE PREFERRED EMBODIMENTS

With reference to the accompanying drawings, preferred embodiments of the present invention are described.

(1) Embodiment 1

A method for managing and dynamically configuring resources (servers) in the VPDC system, according to a preferred Embodiment 1 of the invention, is explained below. In the Embodiment 1, a Web server is deallocated out of user tasks, according to the operating status of the servers allocated to the user.

First, the primary drawings to be used to explain the Embodiment 1 are described.

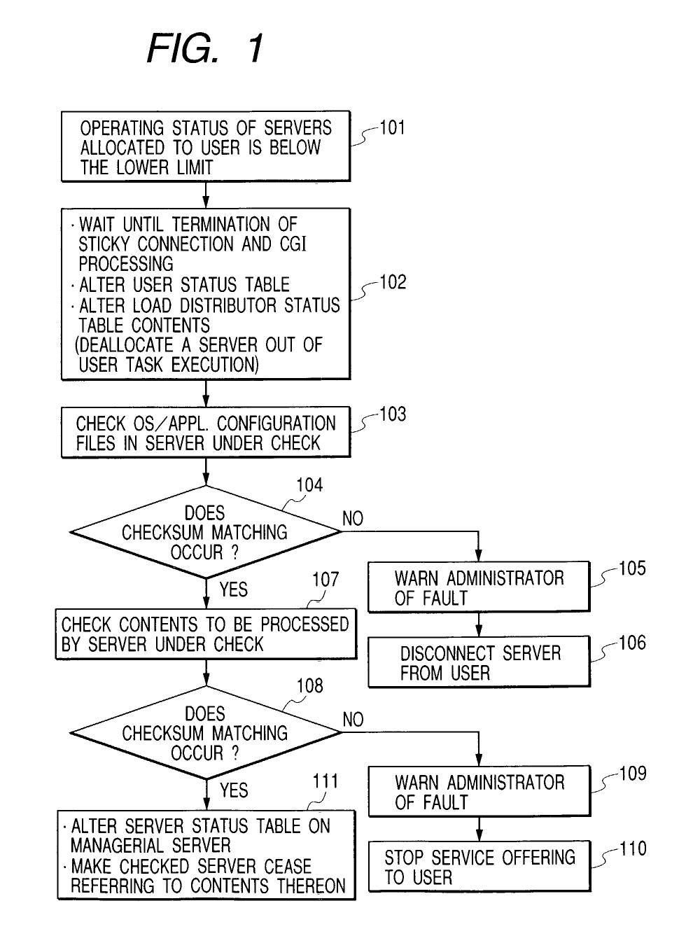

Assuming that a data center for which the present invention facilitates its administration makes a service agreement with users, FIG. 1 illustrates a procedure for deallocating one of the servers to one of the users and a tampering check is performed for the deallocated server.

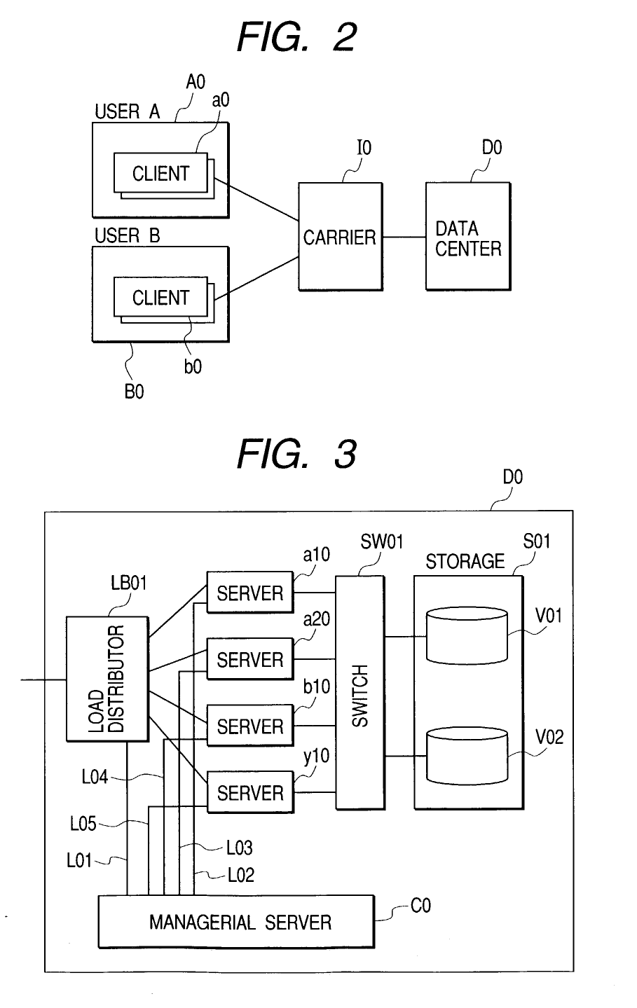

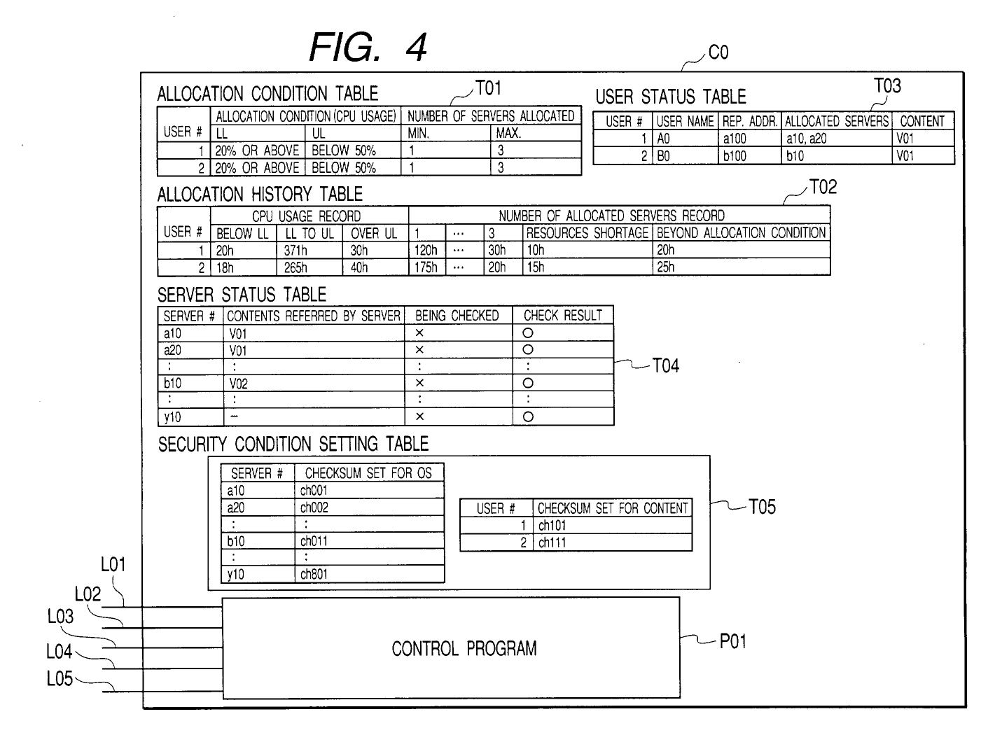

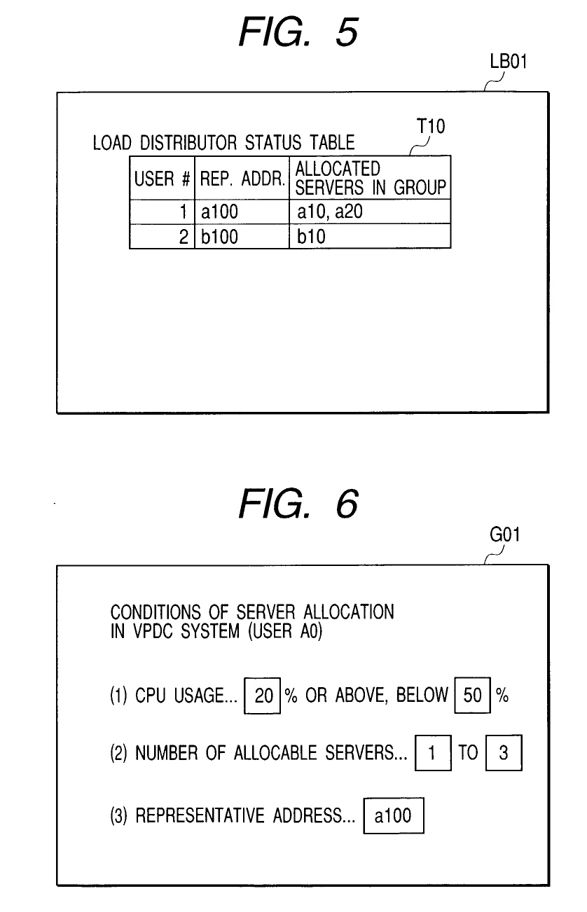

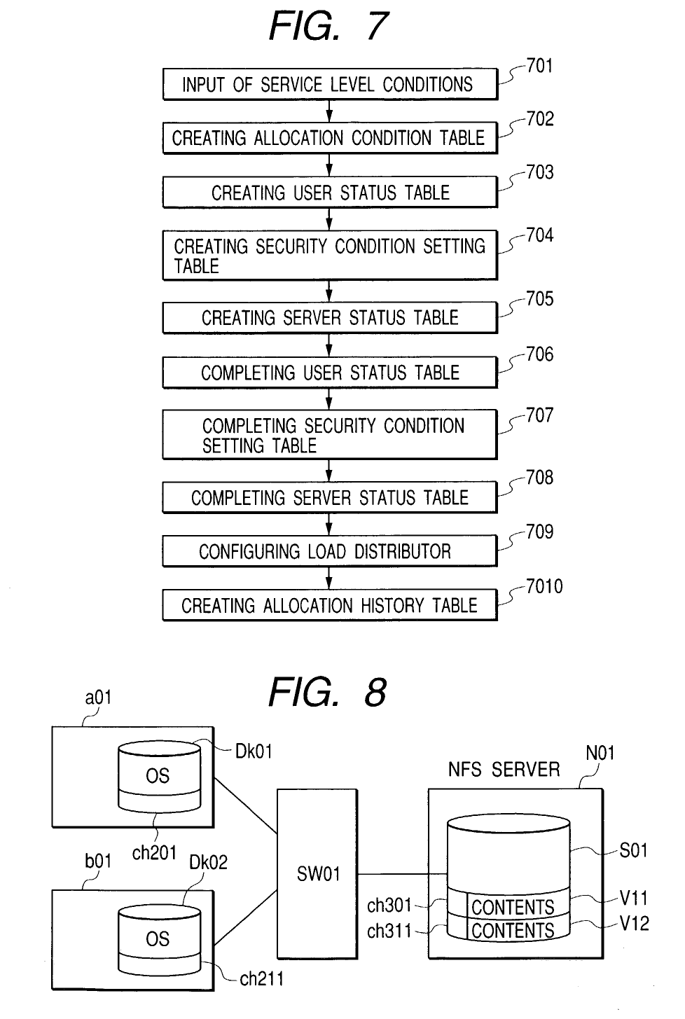

FIG. 2 illustrates an example in which user company A (A0) and user company B (B0) connect to the data center via a network service provider (a carrier) and the Internet (I0). FIG. 3 shows equipment configuration networked within a data center D0. FIG. 4 shows information held by a managerial server C0 of the data center shown in FIG. 3. FIG. 5 shows information held by a load distributor LB01 of the data center. FIG. 6 shows user-specified entries on a window provided for making a service agreement between the data center and the user company A according to the Embodiment 1. FIG. 7 illustrates a procedure in which the resources at the data center are shared across the users when the system boots.

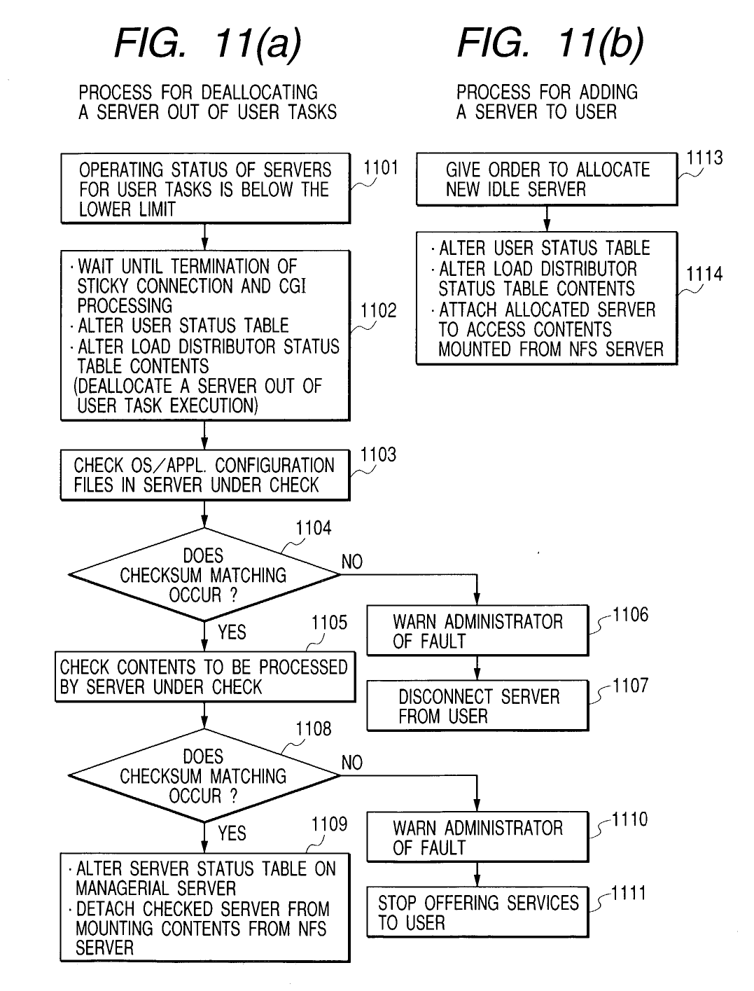

FIGS. 8, 9, and 10 illustrate how to store and furnish the servers with individual contents that respectively belong to the users at the data center D0. FIGS. 11, 12, and 13 respectively illustrates the tampering check procedures corresponding to the different manners for furnishing the servers with individual contents illustrated in FIGS. 8, 9, and 10.

Now, the Embodiment 1 is explained below. A client a0 of the user company A shown in FIG. 2 is assigned with a representative address a100 of a system A0 (that is company A's property) after the data center has made the agreement with company A. The client a0 connects to the data center D0 via the carrier I0. FIG. 3 shows the equipment configuration within the data center D0. This equipment configuration in the data center D0 primarily comprises the load distributor LB01 placed in the forward end, Web servers a10, a20, b10, and y10 behind the load distributor, a switch SW01 behind the servers, and storage S01 with contents V01 and V02 of the users, wherein the servers and the storage are connected via the switch. The equipment configuration further includes a managerial server C0 that obtains the operating status of the Web servers and reconfigures the Web servers and the load distributor. The data center example adopts a two-layer structure composed of a group of the Web servers that provide a Web browser interface in response to user requests and the storage with the contents that respectively belong to the users.

FIG. 6 shows an example of user-specified entries on a window provided for making a service agreement between the data center and the user company A. The contents of the user interface window G01 shown in FIG. 6 state that the data center D0 essentially allocates at least one Web server to user company A or makes at most three servers allocated to the user operating with CPU usage of 20% to 50%. The agreement specifies that, if the total CPU usage reaches 50% or more, additional servers shall be allocated, but a maximum of three Web servers is allocable to the user. The agreement also specifies that, if the total CPU usage falls below 20%, servers shall be deallocated, but a minimum of one Web server must be allocated to the user.

Based on the agreement made between the data center and each user by the input through the window as the example, it is now assumed that web servers a10 and a20 are allocated to company A and a Web server b10 is allocated to company B. While two Web servers are assigned to user company A and one server to user company B in the present embodiment, a maximum of three servers may be allocated to each user, according to the load on the Web servers. Content V01 belongs to company A0, and contents V02 belongs to company B. Servers y10 (idle) are reserved for allocation when the server load for company A or B becomes too large. Two or more servers y10 are available, although only one server y10 is shown in FIG. 3.

Company A is assigned a representative IP address a100 for Web servers, and company B is assigned an representative IP address b100 for Web Servers.

Referring to the relevant drawings, a procedure in which a tampering check for a server allocated to user A is dynamically performed is now explained.

FIG. 4 shows information held by the managerial server C0 of the data center D0 shown in FIG. 3.

In FIG. 4, a table T01 is an allocation condition table in which a control program P01 sets the entries in accordance with the service level conditions entered by user on the window G01 shown in FIG. 6. In this table, the entries are set in accordance with the agreement made between the data center and company A; i.e., at least one Web server is allocated to user A and all servers allocated to the user operate with CPU usage of 20% to 50%. If the upper limit of usage is likely to exceed 50%, additional servers shall be allocated to user A, but a maximum of three servers are allocable to user A. The entries are also set in accordance with the agreement made between the data center and company B; i.e., at least one Web server is allocated to user B and all servers allocated to the user operate with CPU usage of 20% to 50%. If the upper limit of usage is likely to be exceed 50%, additional servers shall be allocated to user B, but a maximum of three servers allocable to user B.

Based on the information set in the table T01 in FIG. 4, an allocation history table T02 is then created. In the allocation history table T02, time values with regard to the past run time of the servers allocated to each user are recorded in columns for the total time of CPU activity over the upper limit of, falling within, and below the lower limit of the agreed CPU usage range of the service level setting. The total CPU activity time is calculated by aggregating all the time of all servers allocated to user, for example, user A. Past activity time information, according to the number of servers allocated, is also recorded. In the “over the upper limit” column of the CPU usage record, the total time during which the servers CPUs operated over the upper limit of the agreed CPU usage set in the allocation condition table is recorded. Over-the-upper-limit cases happen when a load heavier than the processing capacity of the maximum number of servers or when the managerial server tries to allocate an additional server but fails due to the lack of any idle servers. Moreover, in the “resources shortage” column of the allocation history table T02, the time during which the managerial server tried to allocate an additional server but failed due to the lack of any idle servers is entered. In the “beyond allocation condition” column, the time during which a load heavier than the processing capacity of the maximum number of servers is entered.

The managerial server's control program P01 monitors the servers, compares the obtained operation states of the servers with the contents of the allocation condition table T01 in FIG. 4, determines whether the current run of the allocated resources satisfies the service level agreement, and records time values into the allocation history table T02 in FIG. 4 accordingly. If the monitored operation status of the servers does not satisfy the service level agreement, the control program P01 allocates, an additional server or deallocates a server. A user status table T03 in FIG. 4 includes a column of servers allocated to each user and a column of representative address assigned to each user for the management of allocating servers to users.

The user status table T03 in FIG. 4 contains a user ID, a user company name, a representative address, the designations of servers allocated to the user, and the designation of contents of the user. A server status table T04 in FIG. 4 contains server designations, the contents referenced by server, marking of whether the server is being checked for data tampering, and the result of the data tampering check for each server.

A security condition setting table T05 in FIG. 4 contains previously created checksums for the OS environment of a server allocated to each user and the contents that belong to a user. When a data tampering check is performed, a checksum is created and compared with the corresponding checksum stored in the table T05.

Finally, a load distributor status table T10 in FIG. 5 contains a part of the user status table T03 in FIG. 4, i.e., the part applicable to the load distributor LB01.

To implement the above-described control, the managerial server's control program P01 shares the resources across the users when the system boots, and the procedure thereof is explained below with FIG. 7.

First, the user-specified information for service level conditions on the window G01 shown in FIG. 6 is input to the program (701). According to the entered information of service level conditions through the window G01, the managerial server C0 in the data center creates an allocation condition table T01 (702).

According to the entered information shown in FIG. 6, an representative address a100 specified by the user is set in the “representative address” column of the user status table T03 (703). A security condition setting table T05 is also created (704), and a server status table T04 is formed, completed with the “being checked” and “check result” columns (705). Allocating Web servers is then performed with the setup of contents for each user. Referring to the allocation condition table T01, the managerial server sees that at least one server is to be allocated to each user and allocates the servers to satisfy this condition. The allocated servers are set in the “allocated servers” column of the user status table T03 (706). The contents belonging to each user is set in the “contents” column of the user status table T03. The server and contents designations are also set in the “server #” column of the security condition setting table T05 and the “contents” column of the server status table T04, respectively. Then, checksums are created for the OS/application configuration files of each server allocated to a user and the contents belonging to a user by using a data matching check tool. The thus created checksums for the OS and contents are set in the relevant columns of the user security condition setting table T05 (707). Then, the server status table T04 is completed with the “being checked” column filled with crosses (x) and the “check result” column filled with circles (◯). Finally, the load distributor LB01 is configured (709) such that the representative address and the allocated servers per user specified in the relevant columns in the user status table T03 are copied to the load distributor LB01 by transferring data through a signal line L01 to the load distributor LB01. Thus, a load distributor status table T10 shown in FIG. 5 is created.

Furthermore, based on the allocation condition table T01, an allocation history table T02 in FIG. 4 is created (710). That is, the table is formed and completed with the columns of CPU usage record and the columns of the number of allocated servers.

As of now, information required for resource-sharing control has been generated and set on the load distributor LB01, so that the system operation can start with the resources being properly shared across the users.

Then, a procedure in which the managerial server's control program P01 reconfigures the allocated servers due to load change and checks the OS/application configuration files of a server and the contents referenced by the server are explained. Because it is determined whether a server can be deallocated and a server, once deallocated, is checked in the method according to the Embodiment 1, the flowchart illustrating a case where a server is deallocated is shown in FIG. 1. The procedure illustrated in FIG. 1 is explained below.

As described above, the managerial server's control program monitors the operating status of the servers, collects CPU activity time information for the servers through signal lines L01 to L05, and stores that information into the allocation history table 02 in FIG. 4. If the operating status of the servers allocated to a user do not satisfy the allocation conditions for the user, for example, when the servers operate over the upper limit of CPU usage, the managerial server's control program adjusts the number of the allocated servers to satisfy the allocation conditions for the user. After reconfiguring the servers to satisfy the allocation conditions for the user, the control program collects the above information and stores it into the allocation history table T02. The control program compares the operating status of the servers allocated to a user with the contents of the allocation condition table T01 and determines whether a server can be deallocated in light of the service level agreement (101). As another example, determining whether a server can be deallocated is, based on proportional calculation of the product of the CPU usage and the number of allocated servers. If, for example, CPU usage of 20% to 50% is specified as the service level condition for user A0 and three Web servers are now allocated to the user, and if the CPU usage of any server is below 20%, it is determined that the number of Web servers may decrease to two. When the system serves a plurality of users, a server to be deallocated is determined by round robin among all users. In this embodiment, a Web server a20 is to be deallocated. If the server can be deallocated and when the server to undergo a tampering check is placed in Sticky connection and in process of CGI program execution, the managerial server's control program waits until the termination of the process. Then, the control program deletes the server a20 from the “allocated servers” column of the user status table T03 and instructs the load distributor LB01 to delete the Web server a20 from the “allocated servers” column of the load distributor status table T10. Accordingly, the server is set in a state that a load is no longer assigned to it such that it can be checked. Then, the “being checked” column field for the server is filled with a circle (◯) in the server status table T04 (102).

Then, keeping the Web server a20 referring to contents V01, the control program creates a checksum for the OS/application configuration files of the Web server a20 and executes a data matching check (103). The program compares the checksum set for OS ch002 set in the user security setting table T05 and the created checksum for the OS/application configuration files on the Web server a20 (step 04). If a checksum mismatch occurs, the “check result” column field for the server is filled with a cross (x) in the server status table, and the managerial server warns the user and the data center administrator of a fault (step 105). Then, the managerial server disconnects the Web server a20 from the user and stops further service offering to the user with the Web server a20 (step 106). When checksum matching occurs, the control program then creates a checksum for contents referenced by the Web server a20 and executes a data matching check (step 107). The control program compares the checksum set for contents ch101 set in the user security setting table T05 and the created checksum for the contents on the Web server a20 (step 108). If a checksum mismatch occurs, the “check result” column field for the server is filled with a cross (x) in the server status table T04 and the managerial server warns the user and the data center administrator of a fault (step 109). Then, the managerial server stops all of the services of the Web server connected to user A0 (step 110).

When a checksum matching occurs, the “check result” column field is filled with a circle (◯), the “being check column field with a cross (x), and the “contents referenced by server” column field with a dash (-) for the server in the server status table T04. Then, the checked server a20 notified of deallocation from user tasks ceases referring to the contents, terminates program execution, and becomes idle (step 111) so as to serve other clients later. Alternatively, the checked server a20 is relocated to the client after the security check to resume the work load with the continuously available contents.

In FIG. 1, a general method for deallocating a server and performing tampering checks for the deallocated server when reconfiguring the allocated servers is illustrated. Meanwhile, to make available a server with contents, the following three methods are available: mounting contents from the NFS server through which the server accesses the contents; reading contents from a disk system on the network, the disk system having both OS and contents; and cloning, i.e., copying, the original contents to each server. These methods are represented in FIGS. 8 to 10, respectively. Refer to FIGS. 11 to 13, where the described procedures are almost the same as in FIG. 1 for the step of checking contents to be processed by the server under check and the preceding steps, including creating tampering check database and reconfiguring the allocated servers to perform tampering checks are implemented in the same way in FIGS. 11-13. However, these procedures corresponding to different methods of making the contents available as described in detail later.

FIG. 8 depicts a storage system including individual contents that respectively belong to different users when the method of providing a server with contents in the NFS server N01 in the Embodiment 1. The NFS server N01 has a disk S01 in which contents V11 and V12 that belong to the users exist. Web servers a01 and b01 have local disks Dk01 and Dk02, respectively. The corresponding data tampering check procedure is illustrated in FIG. 11. The Web server a01 is allocated to user A and the contents for user A is V11. It means that the Web server a01 mounts the contents V11 in the disk S01. For the Web server 01 allocated to user B, similarly, it mounts the contents V12 in the disk S01.

The steps 1101 to 1111 of the procedure are the same as the corresponding steps in FIG. 1. However, checksums to be used for data tampering checks are created in a different manner. On the Web server a01, a checksum ch201 for the OS/application configuration files is created, using the data on the local disk Dk01 of the Web server, whereas a checksum ch301 for contents is created on the NFS server N01. These checksums ch201 and ch301 created for the OS/application configuration files and the contents are respectively compared with the checksum ch001 set for OS and the checksum ch101 for contents retained in the security condition setting table T05 on the managerial server C0 (steps 1103 and 1108). In step 1109, the server ceases referring to the contents as it belongs to the user by requesting the NFS server to detach it from the referenced contents. That is, the Web server a01 con no longer access the contents V11.

For reconfiguration, an additional server is allocated due to the increasing load on the servers allocated to the user according to the flowchart FIG. 11(b) Judgment is made of regarding whether a new idle server should be allocated to the user. If a new idle server should be allocated, the managerial server C0 gives orders to allocate an idle server to the user (step 1113). After receiving the orders, the control program allocates an additional server to the user, whose process comprises mounting the contents that belongs to the user from the NFS server and reconfiguring the load distributor (step 1114).

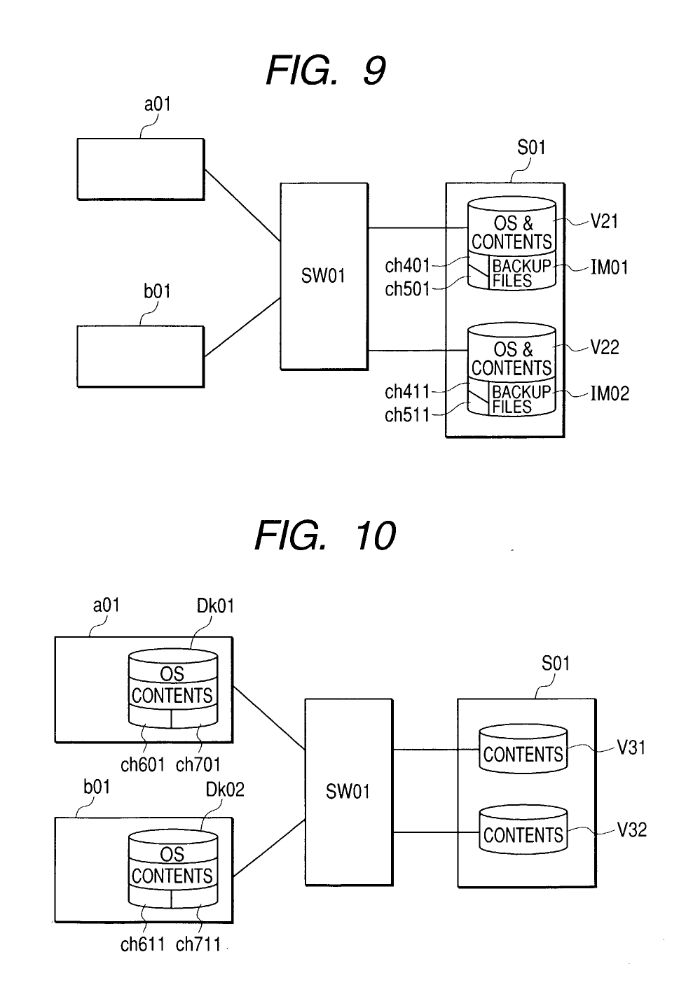

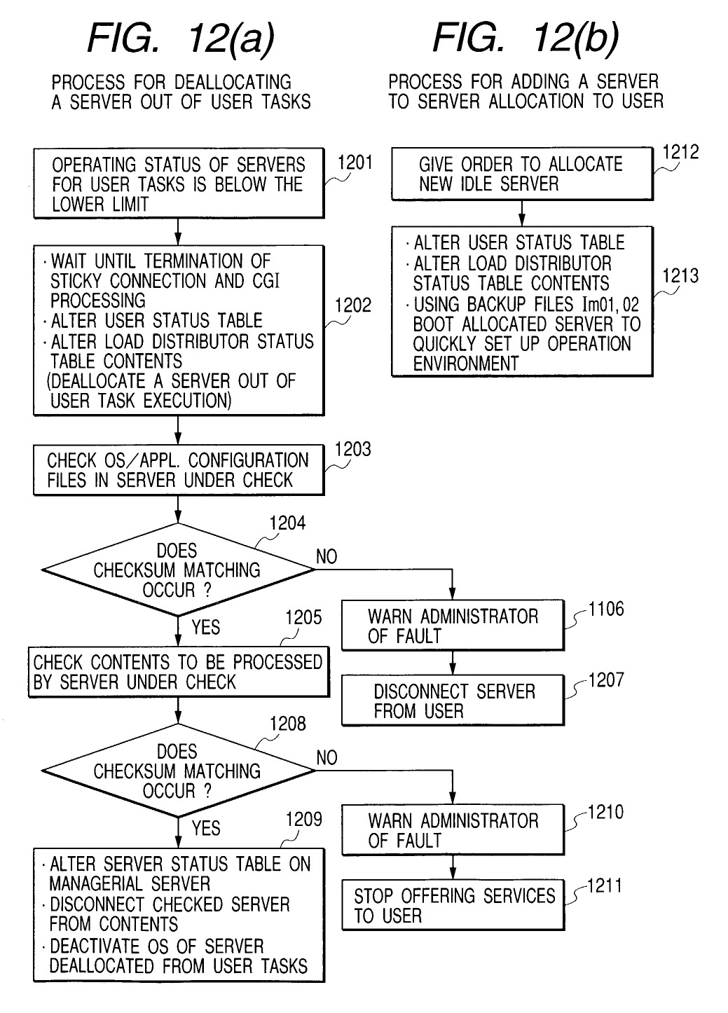

FIG. 9 depicts a storage system including individual contents that respectively belong to the users stored in the disk system on the network in the Embodiment 1. The disk system includes disks V21 and V22 for the users, each of which includes OS and contents for each user. The Web server a01 refers to the contents on the disk V21. It is assumed that, at the start of utilizing the data center, the users create in advance backup files IM01 and TM02, respectively, containing information of OS/application configuration files and contents belonging to each user. The reason why the backup, files are created is as follows. When another server is allocated to a user, a rebooting procedure must be executed on the server. By using the backup file for the server, the time-consuming booting procedure is skipped and the server allocation to the user is quickly performed. The corresponding data tampering check procedure is illustrated in FIG. 12.

The steps 1201 to 1211 of the procedure are the same as the corresponding steps in FIG. 1. However, checksums to be used for data tampering checks are created in a different manner. For the Web server a01, both a checksum ch401 for the OS/application configuration files and a checksum ch501 for contents are created, using the data on the disk V21 on which the OS and the contents are recorded. The thus created checksums for the OS/application configuration files and the contents are respectively compared with the checksum ch01 set for OS and the checksum ch02 for contents retained in the security condition setting table T05 on the managerial server C0.

In step 1209, the server ceases referring to the contents that belongs to the user by deactivating the OS of the deallocated server.

For reconfiguration, to allocate an additional server due to the increasing load on the servers allocated to the user according to the flowchart, FIG. 12(b). First, judgment is made regarding whether a new idle server should be allocated to the user. If a new idle server should be allocated, orders are given to allocate a new idle server to the user (step 1212). After receiving the orders, the control program allocates an additional server to the user, whose process comprises reconfiguring the load distributor and then booting the server based upon the contents retrieved from the disk, which is separate per user, via the network. During this boot-up, the operation environment is recovered by using the appropriate backup file IM01 or IM02 for setting up the operation environment (including OS and contents), instead of normal booting procedure execution. Thereby, the regular booting procedure is skipped, the OS and the contents that belongs to the user can be prepared, and the server allocation to the user can be quickly performed (step 1213).

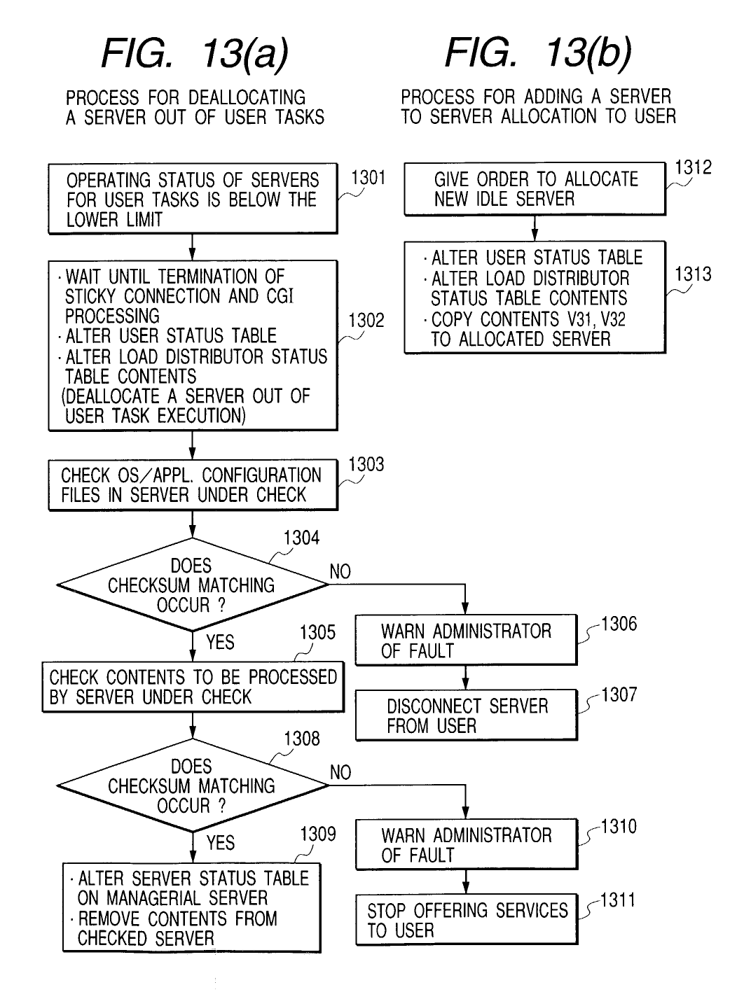

FIG. 10 depicts a storage system including individual contents that respectively belong to the users in the Embodiment 1. In this case, the Web servers have local disks Dk01 and Dk02 respectively. To each server allocated to a user, user's original contents (V31 or V32) to be processed by the server on the master contents server is copied. The corresponding data tampering check procedure is illustrated in FIG. 13.

The steps 1301 to 1311 of the procedure are the same as the corresponding steps in FIG. 1. However, checksums to be used for data tampering checks are created in a different manner. For the Web server a01, both a checksum ch601 for the OS/application configuration files and a checksum 701 for contents are created on the server under check. The thus created checksums ch601 and ch701 are respectively compared with the checksum ch001 set for OS and the checksum ch101 for contents retained in the security condition setting table T05 on the managerial server C0.

In step 1309, the server ceases referring to the contents that belongs to the user by removing the contents from the local disk on the server subjected to managerial processing.

For reconfiguration, to allocate an additional server due to the increasing load on the servers allocated to the user according to the flowchart FIG. 13(b). First, judgment is made regarding whether a new idle server should be allocated to the user. If a new idle server should be allocated, orders are given to allocate a new idle server to the user (step 1312). Then, the control program allocates an additional server to the user, whose process comprises reconfiguring the load distributor and copying the original contents that belongs to the user to the allocated Web server (step 1313).

An advantage of the described reconfiguration methods of the Embodiment 1 is that operation for security management is performed for a server deallocated to be idle. Thus, the server performance for the service offered to the user does not decline. Not only the OS/application configuration files but also the referenced contents belonging to the user can be checked through the operation for security management. Another merit of this method is that the operation for security management can be performed for all setoff OS/application configuration files for the server and all contents data belonging to the user.

(2) Embodiment 2

The following description of a preferred Embodiment 2 concerns a method for periodically performing tampering checks for the OS/application configuration files of Web servers allocated to a user and the contents referenced by the server during the operation of the Web servers at the data center where idle servers exist.

In the system of the Embodiment 2, the data center that implements VPDC control makes an agreement with each user with regard to server allocation conditions and time intervals at which data tampering checks are performed such that the data center runs the servers to satisfy the agreed conditions.

The same relationship between the users, the data center, and the equipment configuration within the data center in the Embodiment 2 as those in the Embodiment 1 will not be repeated.

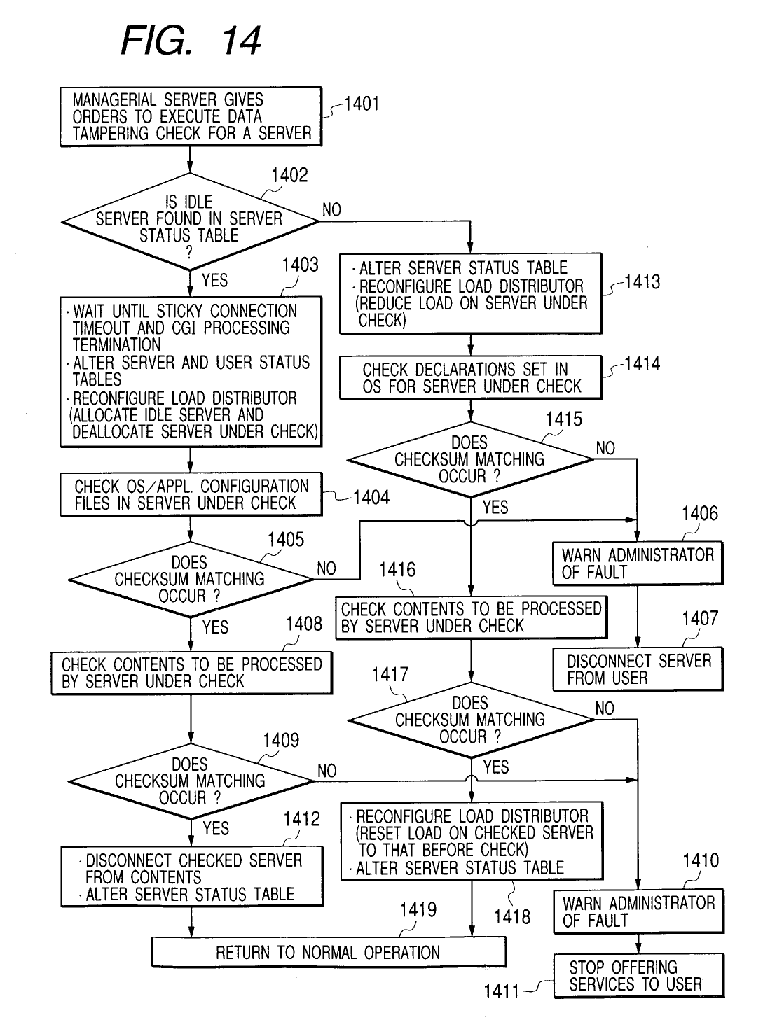

A data tampering check procedure in accordance with the Embodiment 2 is illustrated in FIG. 14.

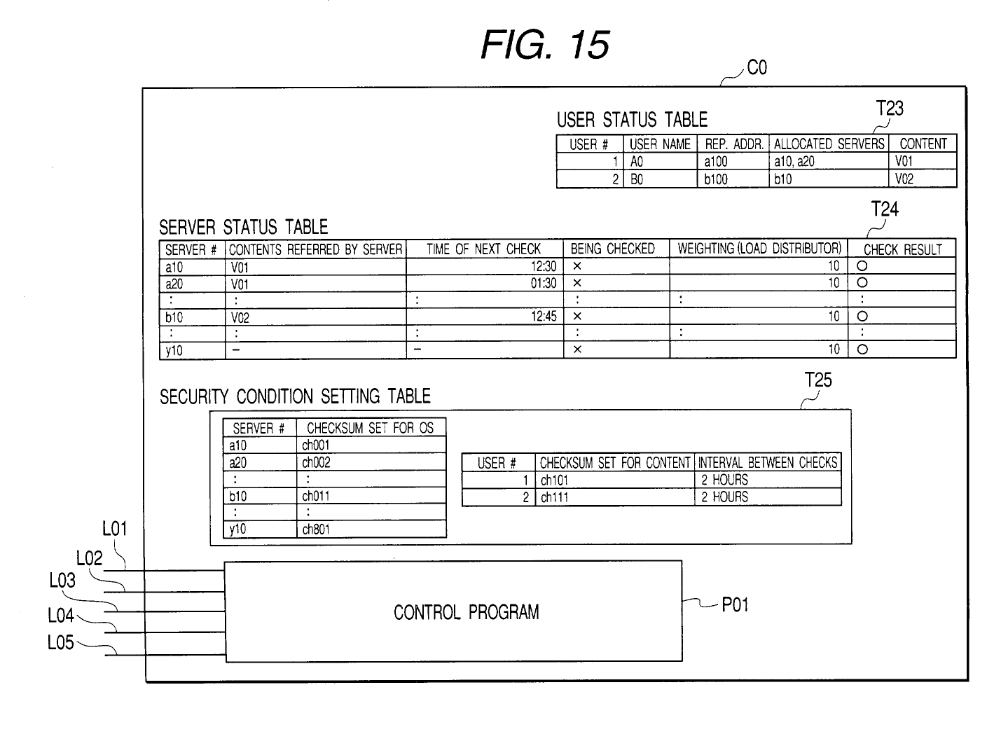

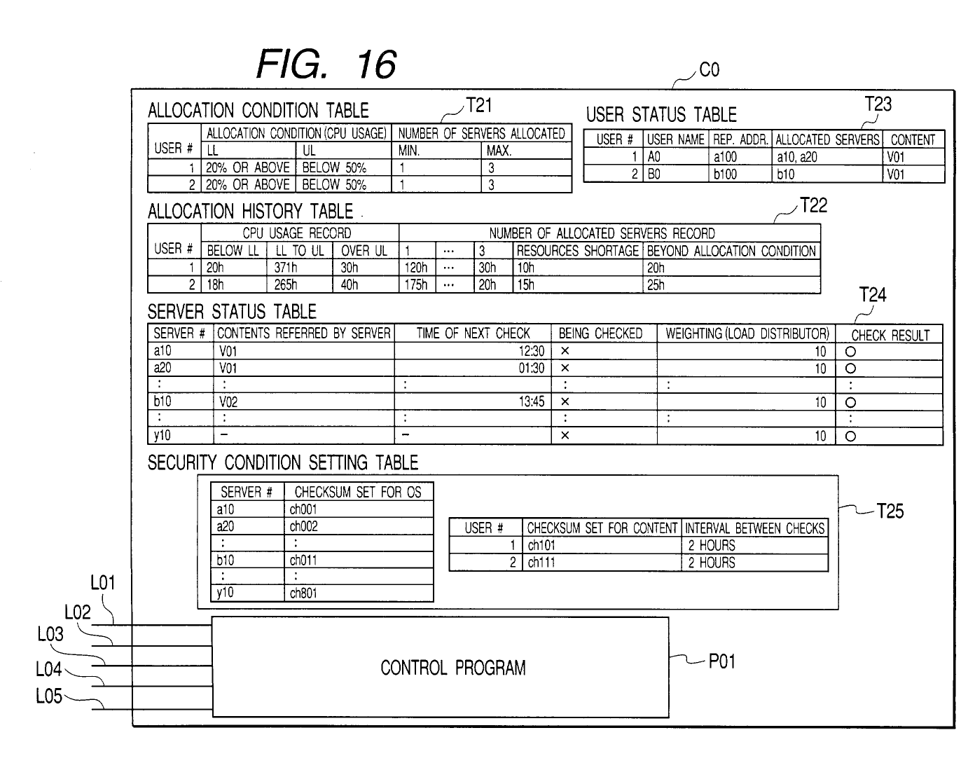

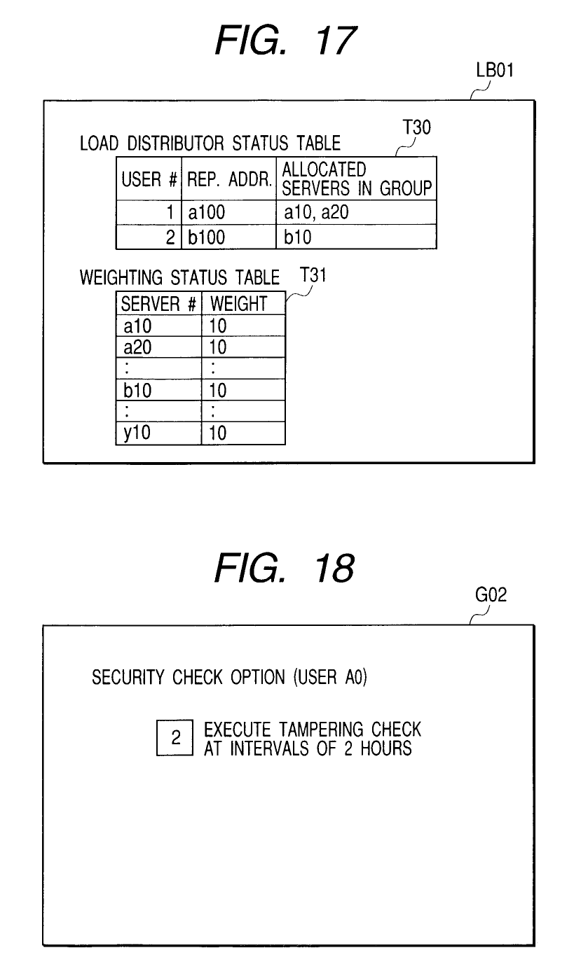

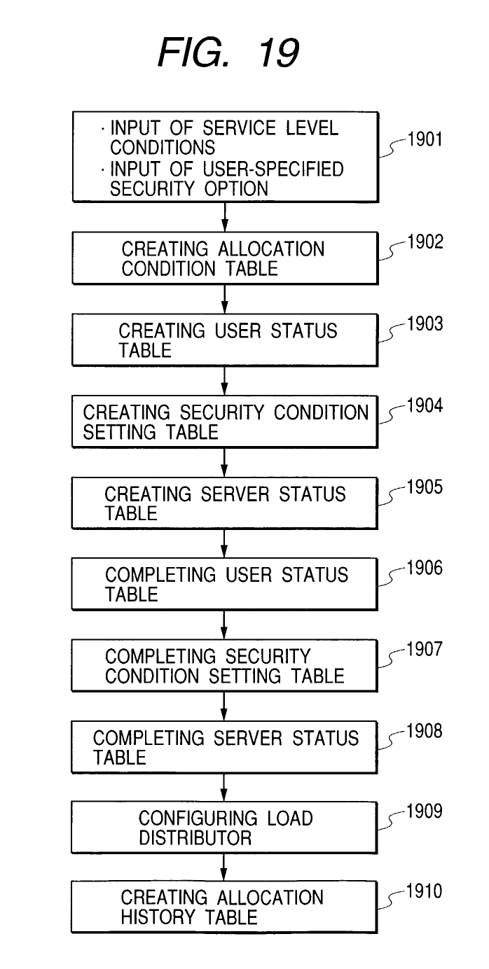

FIG. 15 shows the minimum necessary information to be retained by the managerial server for implementing the Embodiment 2 when VPDC control is not exerted. FIG. 16 shows information held by the managerial server C0 in the data center D0 in the Embodiment 2. FIG. 17 shows information held by the load distributor LB01 in the data center D0 in the Embodiment 2. FIG. 18 illustrates a GUI window example soliciting the user to enter a time interval between data tampering checks to be performed. FIG. 19 illustrates a procedure in which the resources, such as servers, are shared across the users in the Embodiment 2.

A case of the Embodiment 2 where servers allocated to a user are dynamically reconfigured via the VPDC control is explained. Not only in implementing the VPDC control, the method of the Embodiment 2 can also be implemented in a general system if any idle servers exist in the data center without any VPDC control (described later).

Next, a method for performing data tampering checks for a Web server allocated to a user during stable operation of the data center (without being any concurrent decline in the service performance for the users) is described. The Embodiment 2 is explained in a case that a VPDC system operation of the data center dynamically reconfigures the servers allocated to a user. However, non-VPDC system operation is also applicable and, in that case, the number of servers allocated to a user does not change according to the operating status of the servers. To compensate for the work load of a server that is checked for data tampering, the load distribution among the servers allocated to the user is adjusted when the data tampering check is performed. This adjustment can be controlled by a setup procedure be described later.

FIG. 15 shows the minimum necessary information to be held by the managerial server in the data center in the Embodiment 2. If the server status table, the user status table, and the security condition setting table are filled with the necessary data, the Embodiment 2 can be implemented.

FIG. 16 shows information held by the managerial server C0 in the data center D0 shown in FIG. 2.

A table T21 in FIG. 16 is an allocation condition table in which the control program P01 sets the entries in accordance with the service level conditions entered by user on the window G01 shown in FIG. 6. This table is identical to the table T01 in the Embodiment 1 and, therefore, explanation thereof will not be repeated. A server status table in FIG. 16 has a “weighting” column in which weight per server that is set on the load distributor is entered and a “time of next check” column in which the time at which the server will undergo the next data tampering check is entered in addition to the columns existing in the server status table T02 shown in FIG. 4.

A security condition setting table T25 in FIG. 16 has an “interval between checks” column in which a time interval between data tampering checks that the server undergoes is entered in addition to the columns existing in the security condition setting table T05 shown in FIG. 4.

Lastly, a load distributor status table T30 shown in FIG. 17 contains data copied from the columns related to load distribution in the user status table T23 in FIG. 16. A weighting status table T31 is also created to contain data copied from the “weighting” column in the server status table T24.

Meanwhile, FIG. 18 illustrates a window on which a time interval between tampering checks is specified by user. Tampering checks are to be performed for the OS/application configuration files of a server allocated to the user and the contents belonging to the user at intervals of the specified time interval.

For each server allocated to a user, the time as of now plus the interval between checks set in the security condition setting table T25 equals the time of next check set in the “time of next check” column in the server status table T24.

To implement the above-described control, the managerial server's control program P01 shares the resources across the users when the system boots, and the procedure thereof is illustrated in FIG. 19.

First, user-specified information for service level conditions on the window G01 shown in FIG. 6 and the security option condition on the window G02 shown in FIG. 18 is input to the system (step 1901). According to the entered information for service level conditions through the window G01, the managerial server C0 in the data center creates an allocation condition table T21 (step 1902).

According to the entered information for service level conditions through the window G01 shown in FIG. 6, an representative address a100 specified by the user is set in the “representative address” column of the user status table T23 (step 1903). The contents of the security condition setting table T25 are set with an addition of the entered information for security option condition through the window G02 to the table (step 1904). The server status table T24 is formed with the “time of next check,” “being checked,” and “check result” columns filled with the relevant information (step 1905). Allocating Web servers is then performed with the setup of the contents for each user. Referring to the allocation condition table T21, the managerial server ensures that at least one server is allocated to each user. The allocated servers are set in the “allocated servers” column of the user status table T23 (step 1906). The contents belonging to each user is set in the “contents” column of the user status table T23. The server and contents designations are also set in the “server #” column of the security condition setting table T25 and the “contents” column of the server status table T24, respectively. Then, checksums are created for the OS/application configuration files of each server allocated to a user and the contents belonging to a user with a data matching check tool. The thus created checksums for the OS and contents are set in the relevant columns of the user security condition setting table T25 (step 1907). For each server allocated to a user, the “time of next check ” column fields in the server status table T24 are filled with a time value that is set within the interval between checks set in the security condition setting table T25. Moreover, the “being checked” column is filled with crosses (x) and the “check result” column filled with circles (◯) for each server. Then, a value of weighting for each server determined by the administrator is set in the server status table T24 such that the server status table is completed (step 1908). Lastly, the load distributor LB01 is configured (step 1909) such that the representative address and the allocated servers per user specified in the relevant columns of the user status table T23 and the weighting value per server specified in the “weighting” column of the server status table T24 are copied to the load distributor LB01 by transferring the data through the signal line L01 to the load distributor LB01. Thus, a load distributor status table T30 and a weighting status table T31 shown in FIG. 17 are created.

Furthermore, based on the allocation condition table T21, an allocation history table T22 in FIG. 16 is created (step 1910). That is, the table is formed with the columns of CPU usage records and the columns of the number of allocated servers records.

Now, the information required for resources sharing control has been generated and set on the load distributor LB01 such that the system operation can start with the resources being properly shared across the users.

Under these conditions, tampering checks are performed for a server, and the procedure thereof is illustrated in FIG. 14.

The data tampering check procedure is activated at the time of next check set for a server specified in the relevant column of the server status table T24 (step 1401). Then, the “being check” column for the server is filled with a circle (◯) in the server status table T24. Referring to the “contents referenced by server” column of the server status table T24, the managerial server then looks for an idle server whose field of this column contains a dash (-) In principle, an idle server that is found on a higher line in the server status table T24 shall be allocated to the user in place of the server to undergo tampering checks (step 1402).

When any idle servers exist, the managerial server allocates one idle server to the user to which the server to be checked is connected. In this embodiment, it is assumed that the server to undergo the tampering check is a10 and the idle server to be allocated to the user is y10. Thus, this step can be implemented as follows. In the server status table T24, the “being check” column field for the server a10 is filled with a circle (◯) and “V01” is set in the “contents referenced by server” column field for the server y10. In its “time of next check” column field, a time value is set as “the time as of now” plus “the interval between checks” set in the security condition setting table T25. Then, the managerial server C0 copies the information contained in the “representative address” and the “allocated servers” columns of the user status table T23 to the load distributor status table T30 on the load distributor LB01, thereby updating the information. The server “y10” is then added to the field in the “allocated servers” column corresponding to the line of user #1 in the user status table T23, and the managerial server C0 copies this information to the load distributor status table T30 on the load distributor LB01 thereby updating the information.

When the server to undergo the tampering check is placed in a Sticky connection and in a process of a CGI program execution, the managerial server's control program waits until the termination of the process. The server to undergo the tampering check is then deallocated from the group of the servers allocated to the user set on the load distributor. The managerial server C0 deletes server “a10” from the “allocated servers” column for user #1 in the user status table T23 and instructs the load distributor LB01 to alter the “allocated servers” column of the load distributor status table T30 (step 1403). Thereafter, work load is no longer distributed to the server a10.

Then, keeping the Web server a10 referring to contents V01, the control program creates a checksum for the OS/application configuration files of the Web server a10 and executes a data matching check (step 1404). The program compares the checksum set for OS existing in the relevant column of the user security setting table T25 with the created checksum for the OS/application configuration files on the Web server a10 (step 1405).

If a checksum mismatch occurs, the “check result” column field for the server is filled with a cross (x) in the server status table, and the managerial server warns the user and the data center administrator of a fault (step 1406). Then, the managerial server stops the service by the Web server for the user A0 (step 1407).

When a checksum match occurs, the control program creates a checksum for contents referenced by the Web server a10 and executes another data matching check (step 1408). The control program compares the checksum set of the contents existing in the relevant column of the user security setting table T26 with the created checksum for the contents on the Web server a10 (step 1409). If a checksum mismatch occurs, the “check result” column field for the server is filled with a cross (x) in the server status table, and the managerial server warns the user and the data center administrator of a fault (step 1410). Then, the managerial server disconnects the Web server a10 from the user and stops further services offering to the user (step 1411).

When a checksum match occurs, the “check result” column field is filled with a circle (◯) and the “being check” column field with a cross (x) corresponding to the line of server a10 in the server status table T24. Its “contents referenced by server” column field is filled with a dash (-). Moreover, the deallocated server and its checksum set for OS are deleted from the security condition setting table T25. Then, the server a10 checked for data tampering ceases referring to the contents, terminates program execution, and becomes idle (step 1419) so as to serve other clients later. Alternatively, the checked server a20 is relocated to the client after the security check to resume the work load with the continuously available contents.

On the other hand, when it is determined in the step 1402 that no idle server exists, the load distributor is reconfigured for the server to be checked to reduce the load on the server before performing the check. This embodiment is now explained under the assumption that server a10 undergoes such a tampering check.

Following the step 1402, corresponding to the line of server a10 whose “being checked” column field is filled with a circle (◯) in the server status table T24, the initial setting of “10” in the “weighting” column is decreased to “5”. Thereby, the load on the server a10 under check is reduced by a half. After this adjustment, the load on the server under check becomes light so as to perform checks for data tampering for the server, without affecting the user task execution. The managerial server C0 in the data center then instructs the load distributor LB01 to change the value contained in the “weighting” column field for the server in its table to the changed weighting value (step 1413).

After the reconfiguration of the load distributor, the control program creates a checksum for the OS/application configuration files of the Web server a10 and executes a data matching check (step 1414). Specifically, the program compares the checksum set for OS existing in the relevant column of the user security setting table T25 with the created checksum for the OS/application configuration files on the Web server a10 (step 1415).

If a checksum mismatch occurs, the “check result” column field for the server is filled with a cross (x) in the server status table, and the managerial server warns the user and the data center administrator of a fault (step 1406). Then, the managerial server disconnects the Web server a10 from the user and stops further service offering to the user from the Web server a10 (step 1407).

When a checksum match occurs, the control program then creates a checksum for contents referenced by the Web server a10 and executes another data matching check (step 1416). The control program compares the checksum set for contents existing in the relevant column in the user security setting table T25 with the created checksum for the contents on the Web server a10 (step 1417). If a checksum mismatch occurs, the “check result” column field for the server is filled with a cross (x) in the server status table, and the managerial server warns the user and the data center administrator of a fault (step 1406) Then, the managerial server stops the service of the Web server connected to the user A0 (step 1407).

When a checksum match occurs, the “check result” column field is filled with a circle (◯) and the “being check column field with a cross (x) corresponding to the line of the server a10 in the server status table T24. Then, the weighting value for the server in the “weighting” column of the server status table T24 on the managerial server C0, namely, the value of “5” to which the initial value changed in the step 1413 is reset to “10”. Similarly, the value for server a10 in the “weighting” column of the weighting status table T31 on the load distributor LB01 is reset. Accordingly, the load on the server a10 is reset to that before the check (step 1418). Then, the server a10 checked for data tampering returns to normal processing operation as a Web server (step 1419).

In the case in a non-VPDC system operation, the number of servers allocated to a user does not change according to the operating status of the servers. To compensate for the work load of a server to be checked for data tampering, the load distribution among the servers allocated to the user is adjusted such that the data tampering check can be performed. This adjustment can be controlled in the same way as the above-described setup procedure.

FIG. 15 shows the minimum necessary information to be held by the managerial server in the data center in the Embodiment 2. If the server status table, the user status table, and the security condition setting table are filled with the necessary data, the Embodiment 2 can be implemented.

The described reconfiguration method of the Embodiment 2 has the following advantages. An idle server, if exists, is allocated to the user in place of the server to be checked and no new load is assigned to the server for which the OS/application configuration files and the contents referenced by it are checked. Consequently, the data center continues offering services to the user, while the user task processing performance of the servers does not decline during the execution of the tampering checks for the server. Even if no idle server exists, the load assigned to the server to be checked is reduced to minimize a decline in the user task processing performance. Therefore, the data center can continue to offer services with a minimum decline in service performance, during the execution of the tampering checks for the server.

(3) Modification Example 1 to Embodiment 1

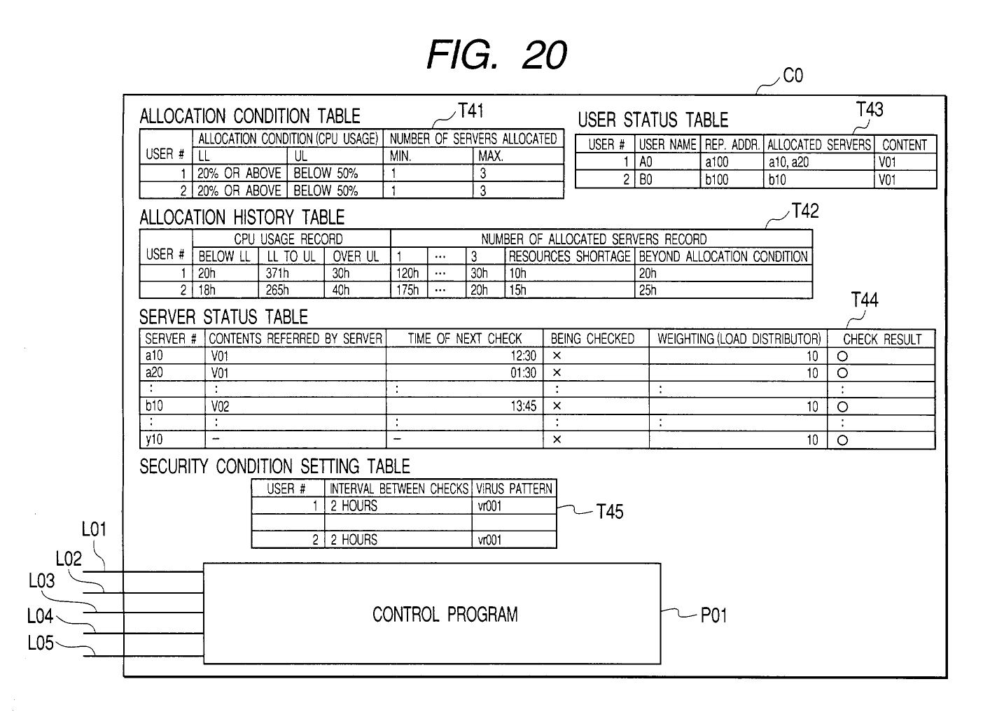

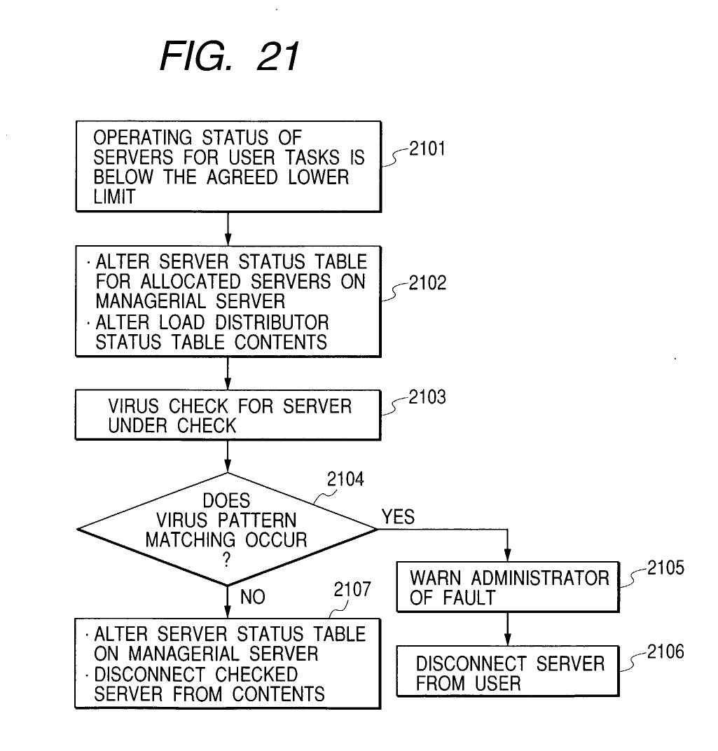

Embodiment 1 explained in FIG. 1, wherein a server is deallocated from the group of servers allocated to a user and checked for data tampering is modified such that a virus check is performed for the sever. In this modification example, information held by the managerial server is exemplified in FIG. 20 and a flowchart of the procedure for performing the virus check is illustrated in FIG. 21. This modification example can be implemented in exactly the same way as the Embodiment 1, and particularly checking to see whether virus pattern matching occurs. If a virus pattern matching occurs, the system disconnects the server from the user.

(4) Modification Example 1 to Embodiment 2

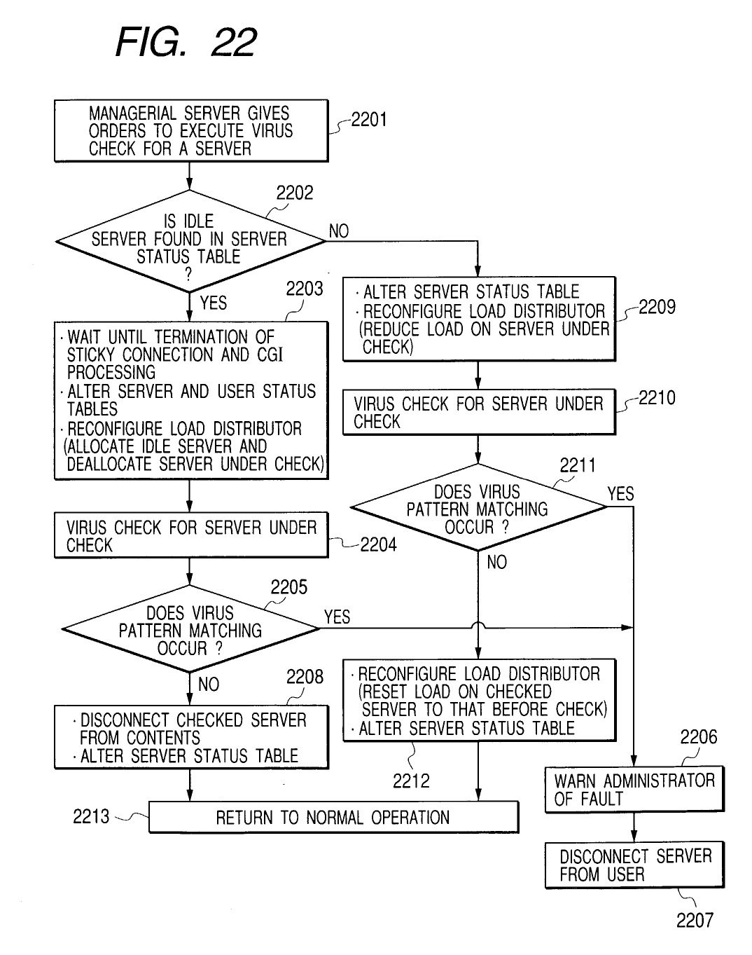

Embodiment 2 explained, using FIG. 14, wherein judgment is made regarding whether an idle server can be allocated, and the check procedure is carried out by allocating an idle server to a user and deallocating a server under check out of user tasks, or if an idle server cannot be allocated, reducing the load on the server under check, and executing the check. A virus check instead of the tampering check may be performed for the server. Information held by the managerial server is shown in FIG. 20 for this modification example. A flowchart of the procedure for performing the virus check is illustrated in FIG. 22. This procedure is the same as for the Embodiment 2 except checking to see whether virus pattern matching occurs. If the virus pattern matching occurs, the system disconnects the server from the user. This embodiment can be implemented in a general system and a system serving a single user only if an idle server exists in the system.

(5) Modification Example 2 to Embodiment 1

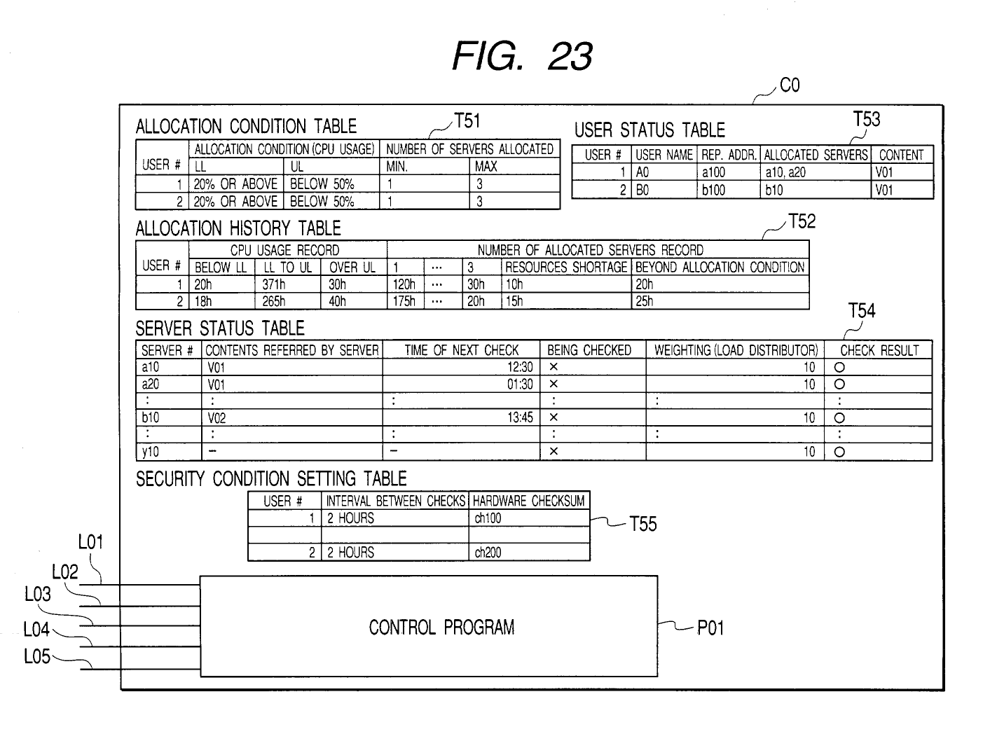

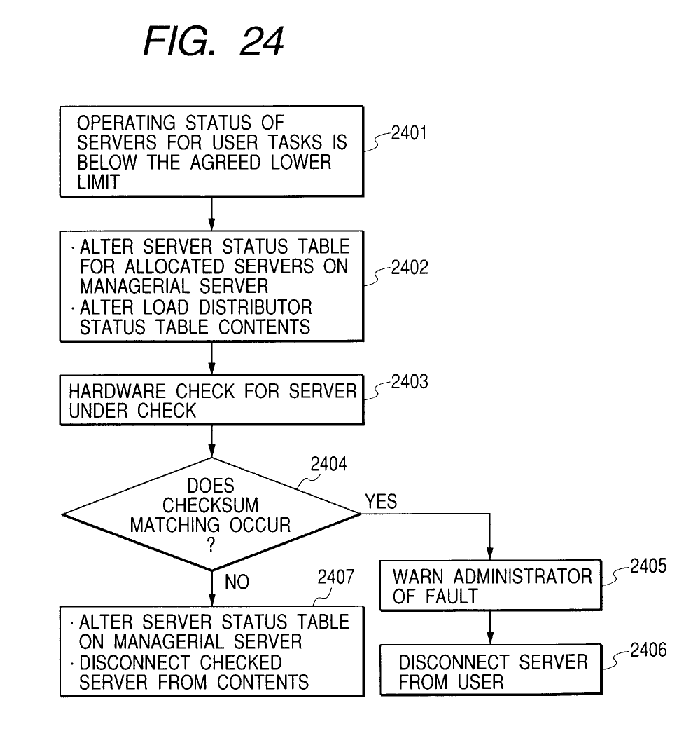

The Embodiment 1 is modified such that a server's hardware check is performed. Information held by the managerial server is exemplified in FIG. 23, and the procedure for performing the hardware check is illustrated in FIG. 24. The procedure of this modification example is the same as for the Embodiment 1, and particularly checking to see whether hardware's reply pattern is correct.

(6) Modification Example 2 to Embodiment 2

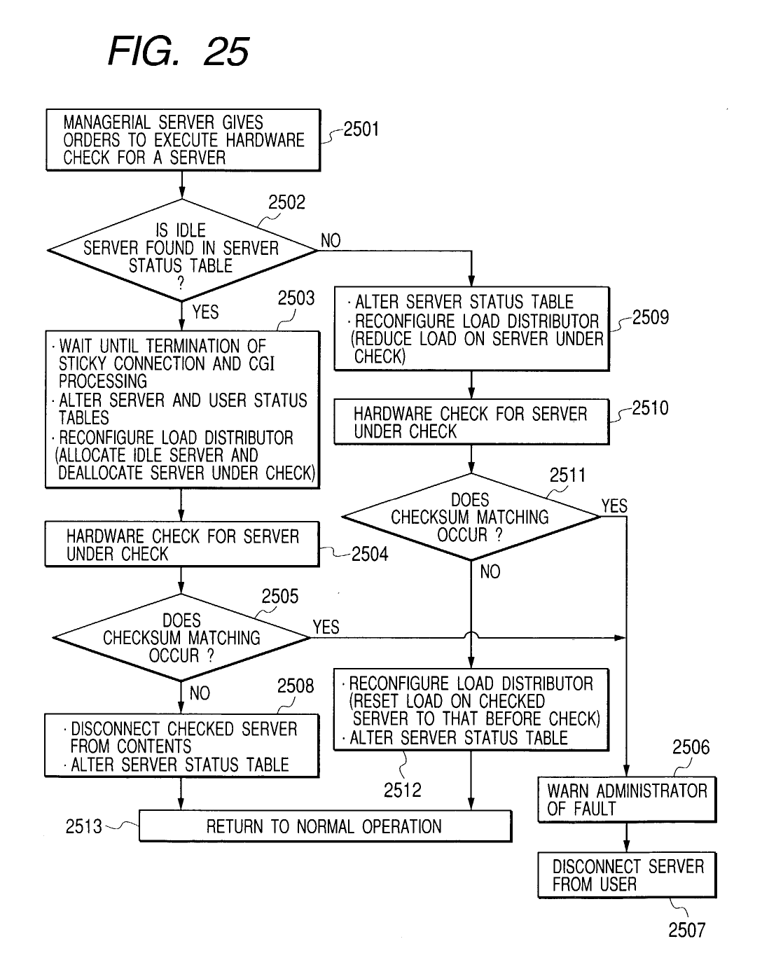

The Embodiment 2 can also be modified such that a server's hardware check is performed. Information held by the managerial server is shown in FIG. 20, and the procedure for performing the hardware check is illustrated in FIG. 25. The procedure of this modification example is the same as the Embodiment 1, and particularly checking to see whether hardware's reply pattern is correct. As is the case for the Embodiment 2 and its modification example 1, the modification example 2 can be implemented in a system serving a single user only if an idle server exists in the system.

(7) Modification Example 3 to Embodiment 1

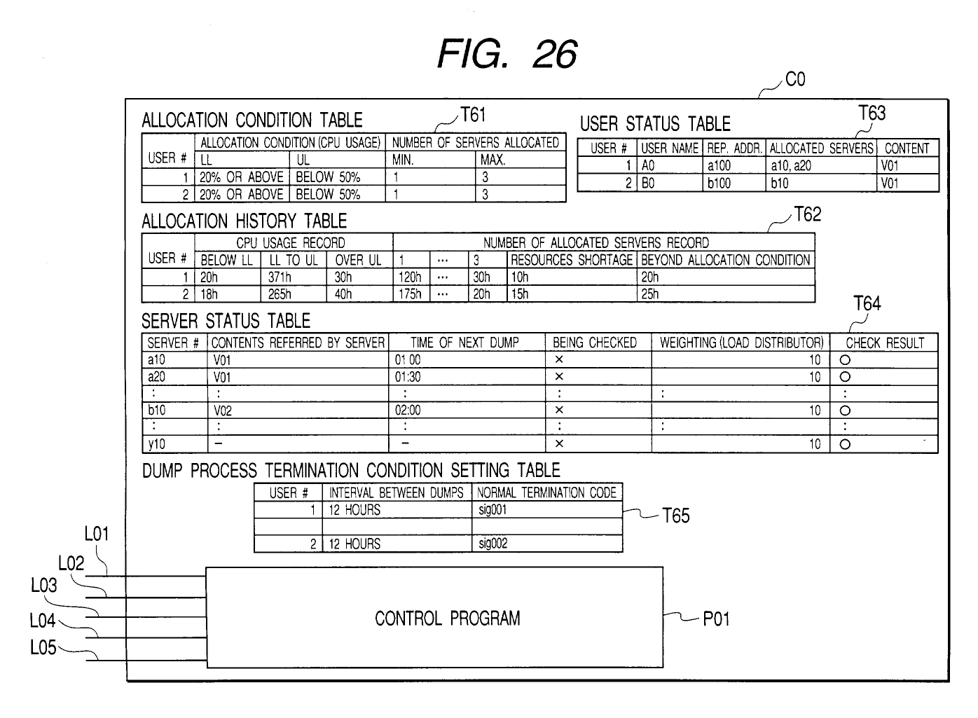

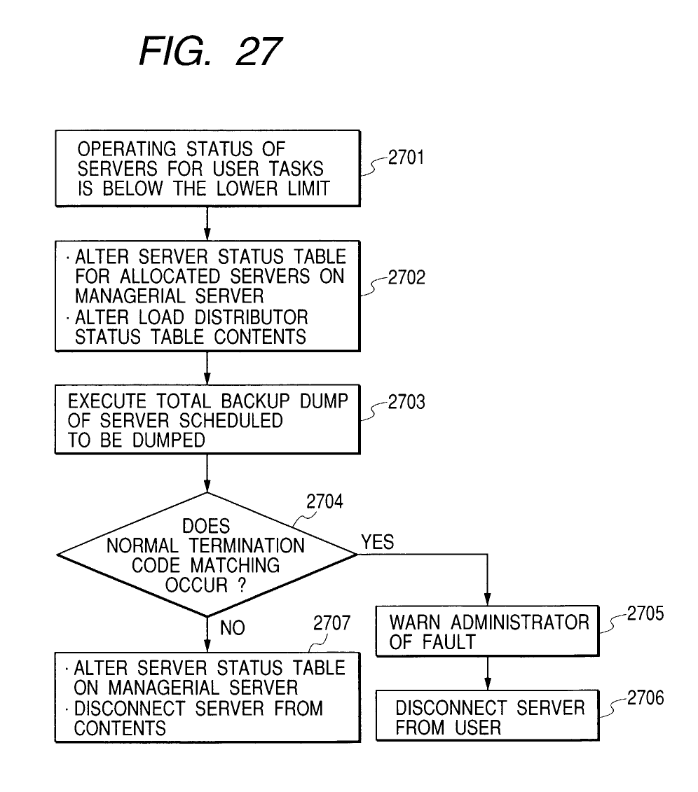

The Embodiment 1 is modified such that a backup dump of a server is performed. Information held by the managerial server is exemplified in FIG. 26, and the procedure for performing the backup dump is illustrated in FIG. 27. The procedure of this modification example is the same as the Embodiment 1, and particularly checking to see whether the termination code returned at the end of a backup dump is a normal end as desired.

(8) Modification Example 3 to Embodiment 2

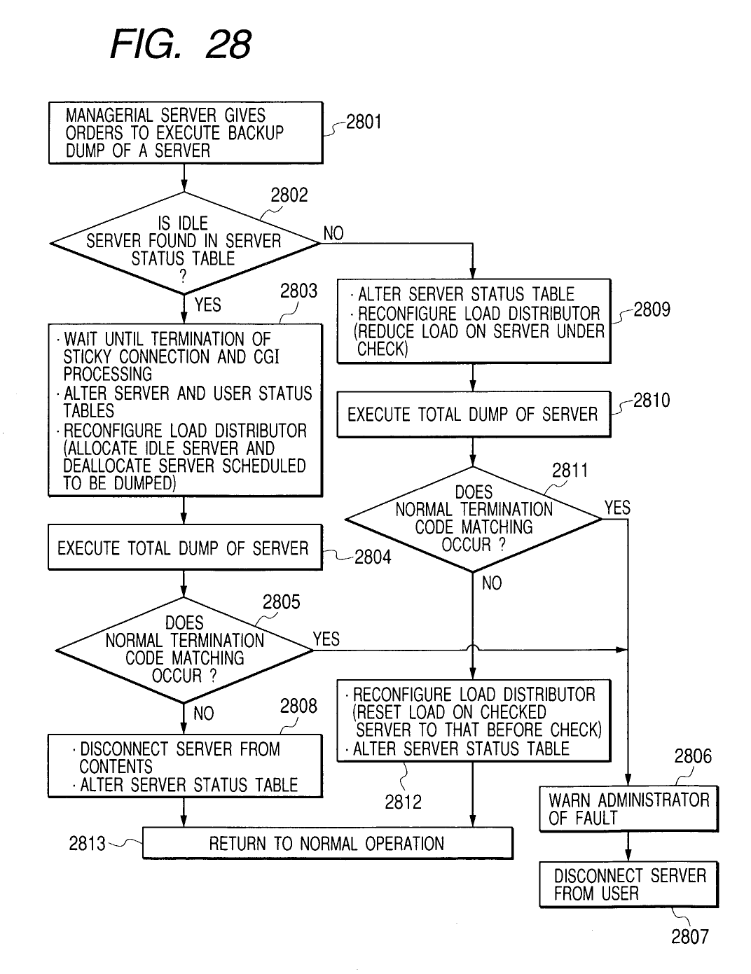

Embodiment 2 can also be modified such that a backup dump of a server is performed. Information held by the managerial server is shown in FIG. 26, and the procedure for performing the backup dump is illustrated in FIG. 28. The procedure of this modification example is the same as the Embodiment 2, and particular checking to see whether the termination code returned at the end of a backup dump is a normal end. As is the case in the Embodiment 2 and its foregoing examples, this modification example can also be implemented in a system serving a single user only if an idle server exists in the system.

In the present invention, the managerial server in the data center is provided with the allocation condition table in which the allocation conditions per user are stored, the user status table in which the users and the servers allocated to them are stored, the server status table in which the status of the servers are stored, and the security condition setting table in which the security conditions per user are stored. The servers allocated to the users can be reconfigured by altering the settings in these tables. By properly reconfiguring the servers allocated to a user, operation for security management can be performed for one of the servers without any decline in the user task processing performance of the servers. Such reconfiguration is performed by proper determination of the operating status of the servers. In addition, the operation for security management can be performed automatically for one of the servers allocated to a user at regular time intervals that are set in the managerial server, while the user task processing performance of the servers does not decline.

The principles, preferred embodiments and modes of operation of the present invention have been described in the foregoing specification. However, the invention which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method for dynamically distributing work load among a plurality of web servers in a computer system upon a change of the work load and configuring the servers accordingly, comprising:
dedicating at least one web server to be idle among web servers allocated to one user;
idling the dedicated server by reconfiguring load distribution means to block the user form accessing the dedicated server; and
performing operation for security management on the idled server, while contents that belong to the user are kept available for the idled server.

2. The method according to claim 1, wherein, when the dedicated server is placed in Sticky connection or executing a CGI program, the reconfiguring step is postponed until the dedicated server leaves the Sticky connection or terminates the CGI program.

3. The method according to claim 1, wherein the contents that belongs to the user is kept available for the idled server by making available the contents for the idled server.

4. The method according to claim 1, wherein the operation for security management performing step involves comparing current checksums of an OS/application configuration file and the contents with recorded ones.

5. The method according to claim 1, wherein the operation for security management includes at least one of a virus check, a hardware check and a backup dump.

6. A method for dynamically distributing work load among a plurality of web servers in a computer system upon a change of the work load and configuring the servers accordingly, comprising:
determining whether any idle server which is not allocated to any users exists when one of the web servers allocated to one user needs operation for security management;
if the idle server is available, dedicating the idle server to the user by making available for the idle server contents that belong to the user based upon which the idle server takes over work load of said server which needs operation for security management;
idling said server which needs operation for security management by reconfiguring load distribution thereby blocking the user form accessing said server which needs operation for security management; and
performing operation for security management on said server which needs operation for security management, while the contents that belongs to the user is kept available for said server which needs operation for security management.

7. The method according to claim 6, further comprising a step of, if no idle server is available, reducing work load on said server which needs operation for security management by redistributing the work load to other servers allocated to the user so as to perform the operation for security management on said server.

8. The method according to claim 7, wherein, when the operation for security management is finished, the work load on said server is reset back on said server.

9. The method according to claim 6, wherein the operation for security management performing step involves comparing current checksums of an OS/application configuration file and the contents with recorded ones.

10. The method according to claim 6, wherein the operation for security management includes at least one of a virus check, a hardware check and a backup dump.

11. The method according to claim 6, further comprising:
storing the contents that belongs to the user in a NFS server to be shared by the web servers allocated to the user; and
detaching the idle server from the NFS server when the operation for security management is finished for said server which needs operation for security management.

12. The method according to claim 11, wherein the operation for security management includes a tampering check of the contents that belong to the user and are referred to by said server by accessing the NFS server.

13. The method according to claim 6, further comprising:
initializing in each of the plurality of the web servers an operation environment by using a backup file of the operation environment which has been created beforehand and stored in a disk system connected with the computer system for storing respective contents belonging to respective users; and
clearing the initialized operation environment from the idle server when the operation for security management is finished for said server which needs operation for security management.

14. The method according to claim 6, further comprising:
copying the contents that belong to the user from a content server storing individual contents of each user to the idle server; and
removing the contents that belong to the user from the idle server when the operation for security management is finished for said server which needs operation for security management.

15. A computer system for dynamically distributing work load therein upon a change of the work load and configuring the servers accordingly, comprising:
a plurality of web servers; and a managerial server for determining whether any idle server which is not allocated to any users exists when one of the web servers allocated to one user needs operation for security management;
if the idle server is available, dedicating the idle server to the user by making available for the idle server contents that belong to the user based upon which the idle server takes over work load of said server which needs operation for security management;
idling said server which needs operation for security management by blocking the user form accessing said server which needs operation for security management; and
performing operation for security management on said server which needs operation for security management, while the contents that belongs to the user is kept available for said server which needs operation for security management.

16. The computer system according to claim 15, wherein, if no idle server is available, the managerial server reduces work load on said server which needs operation for security management by redistributing the work load to other servers allocated to the user so as to perform the operation for security management on said server.

17. The computer system according to claim 15, wherein, when the operation for security management is finished, the work load on said server is reset back on said server.

18. The computer system according to claim 15, further comprising: a NFS server for storing the contents that belongs to the user so as to be shared by the web servers allocated to the user, wherein the idle server is detached from the NFS server when the operation for security management is finished for said server which needs operation for security management.

19. The computer system according to claim 15, further comprising:
a disk system connected with the computer system for storing respective contents belonging to respective users, wherein
each of the plurality of the web servers is initialized with an operation environment by using a backup file of the operation environment which has been created beforehand and stored in the disk system, and
the initialized operation environment is cleared from the idle server when the operation for security management is finished for said server which needs operation for security management.

20. The computer system according to claim 15, further comprising:
a content server for storing and copying the contents that belong to the user therefrom to the idle server, wherein
the contents that belong to the user is removed from the idle server when the operation for security management is finished for said server which needs operation for security management.
